(19) United States
(12) Patent Application Publication
(10) Pub. No.: US 2024/0069179 A1
(43) Pub. Date: Feb. 29, 2024

(54) LIDAR MODULE HAVING ENHANCED ALIGNMENT AND SCANNING

(71) Applicant: LG INNOTEK CO., LTD., Seoul (KR)

(72) Inventors: Mark ltzler, Princeton, NJ (US); Igor Kudryashov, Pennington, NJ (US); Yu Jin, Lawrenceville, NJ (US); Viorel C. Negoita, Plainsboro, NJ (US)

(73) Assignee: LG INNOTEK CO., LTD., Seoul (KR)

(21) Appl. No.: 18/322,285

(22) Filed: May 23, 2023

Related U.S. Application Data
(60) Provisional application No. 63/402,117, filed on Aug. 30, 2022.
(60) Provisional application No. 63/402,126, filed on Aug. 30, 2022.
(60) Provisional application No. 63/402,333, filed on Aug. 30, 2022.

(51) Int. Cl. G01S 7/497; G01S 7/481; G01S 17/10

(52) U.S. Cl. CPC G01S 7/4972; G01S 7/4817; G01S 17/10

(57) ABSTRACT

An optical transmitter including a laser diode array configured to emit corresponding laser pulses; a micro-optics module configured to focus the laser pulses into a scanning beam; and a drive motor configured to rotate the optical transmitter so the scanning beam covers a horizontal field of view.

### CROSS REFERENCE TO RELATED APPLICATIONS

This application claims the benefit under 35 U.S.C. § 119(e) to U.S. Provisional Application No. 63/402,126, filed on Aug. 30, 2022, 63/402,117, filed on Aug. 30, 2022, and 63/402,333, filed on Aug. 30, 2022, all of which are hereby expressly incorporated by reference into the present application.

### BACKGROUND OF THE INVENTION

### 1. Field of the Invention

The present disclosure is related to using light detecting and ranging (lidar) with autonomous vehicles.

### 2. Background of the Invention

Autonomous vehicles (AVs) use a plurality of sensors for situational awareness. The sensors, which can be part of a self-driving system (SDS) in the AV, include one or more cameras, lidar, inertia measurement unit (IMU), etc. Sensors such as cameras and lidar are used to capture and analyze scenes around the AV. The captured scenes are then used to detect objects including static objects such as fixed constructions, and dynamic objects such as pedestrians and other vehicles. In addition, data collected from such sensors can also be used to detect conditions such as road markings, lane curvature, traffic lights and signs, etc. Further, a scene representation such as 3D point cloud obtained from the AV's lidar can be combined with one or more images from the cameras to obtain further insight to the scene or situations around the AV.

Further, the lidar transceiver can include photodetectors to convert incident light or other electromagnetic radiation in the ultraviolet (UV), visible, and infrared spectral regions into electrical signals. Photodetectors can be used in a wide array of applications including, for example, fiber optic communication systems, process controls, environmental sensing, safety and security, and other imaging applications such as light detection and ranging applications. High photodetector sensitivity allows for detection of faint signals returned from distant objects. However, such sensitivity to optical signals requires a high degree of alignment between its components and alignment in the emission of the lasers.

However, challenges arise using a linear merit function for optimal position calculation. For example, there are multiple components or parameters in an AV, which are dependent on each other. Thus, it is difficult to separately perform the active alignment for each dependent component. Thus, in the related art method, one parameter could be over-weighted making another parameter out of specification. A low resistance to external noise also makes it difficult, especially when using a gradient descent, to find an optimal position.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### SUMMARY OF THE INVENTION

Accordingly, an object of the present invention is to address the above-noted and other problems with the related art.

In another aspect, the present invention provides active alignment for optical systems such as a laser module including VBG laser diodes to find optimal positions for the optical components.

In still another aspect, the present invention provides an algorithm to identify the optimal position and efficient scan methods to achieve high yield and fast process times.

In yet another aspect, the present invention provides a lidar transceiver including a transmitter module (e.g., laser module) and associated transmitter optics working together to emit a uniform space filling imaging scan.

In another aspect, the present invention provides a system and method for active optical alignment of laser modules to improve production tolerances and increase device manufacturing yields.

To achieve these and other advantages and in accordance with the purpose of the present invention, as embodied and broadly described herein, the present invention provides in one aspect an optical transmitter including a laser diode array configured to emit corresponding laser pulses; a micro-optics module configured to focus the laser pulses into a scanning beam; and a drive motor configured to rotate the optical transmitter so the scanning beam covers a horizontal field of view.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will become more fully understood from the detailed description given hereinbelow and the accompanying drawings, which are given by illustration only, and thus are not limitative of the present invention, and wherein:

FIG. 1A is an overview of a lidar light pattern with non-imaged gaps;

FIG. 1B is a table comparing a Geiger-Mode lidar to a Legacy Liner-Mode lidar;

FIG. 2 is a block diagram of a lidar system according to an embodiment of the present disclosure;

FIG. 3 is a perspective view of a laser module depicting six axes of movement;

FIG. 4 includes graphs illustrating using linear and non-liner merit functions according to an embodiment of the present disclosure;

FIG. 5 is an image of area scan profile including A and B axes;

FIG. 6 is an overview illustrating decoupling of the A/B axis by linear interpolation according to an embodiment of the present disclosure;

FIG. 7 is a flow diagram illustrating adjusting a scan range in multiple steps according to an embodiment of the present disclosure;

FIG. 8 is a diagram illustrating a three-scan process when a peak position has a quadratic behavior according to an embodiment of the present disclosure;

FIG. 9 is an overview of a lidar transceiver module according to an embodiment of the present disclosure;

FIG. 10 is an overview illustrate additional details of the light transceiver module shown in FIG. 9;

FIG. 11 is an overview illustrating a space filling imaging beam operation according to an embodiment of the present disclosure;

FIGS. 12A and 12B are overviews illustrating the space filling imaging beam operation including over-sampling techniques according to an embodiment of the present disclosure;

FIG. 13 is an overview illustrating a monolithic optical element separated from a laser diode array and within the field of light emission to influence a shape of the light output from the emitters according to an embodiment of the present disclosure; and

FIG. 14 is an overview of FIG. 13 with an inoperable light emitter according to an embodiment of the present disclosure.

### DETAILED DESCRIPTION OF THE INVENTION

Reference will now be made in detail to the preferred embodiments of the present invention, examples of which are illustrated in the accompanying drawings.

The discrete lasers and detectors in the related art also generate gaps between imaged points because the pulses are transmitted in a scatter fashion leaving gaps between each scanned scene. Such gaps produce lower quality maps affecting detection, classification, tracking, and projection of detected objects. Particular in autonomous applications, this method yields sub-par performance for autonomous navigation.

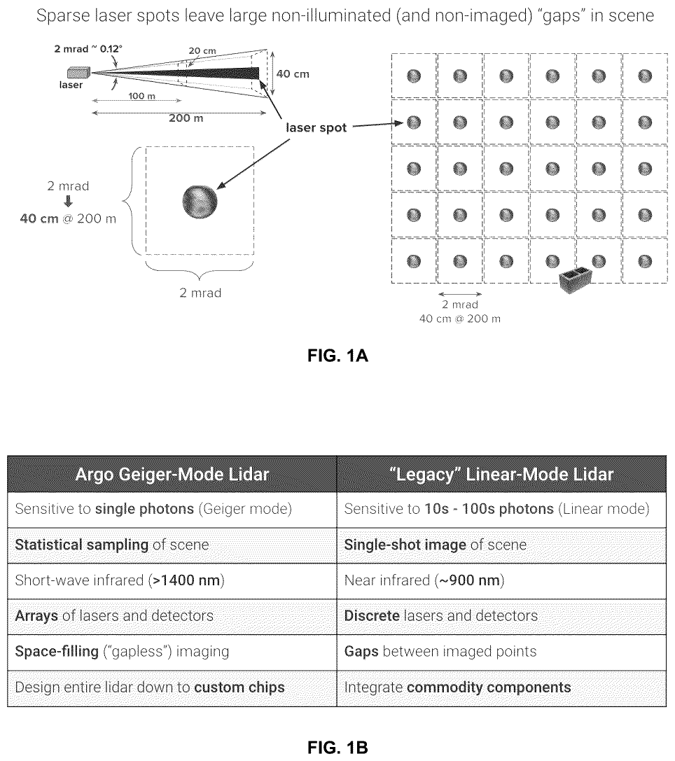

In particular, FIG. 1A is an overview illustrating sparse laser spots leaving large non-illuminated and non-imaged gaps in the scene, and FIG. 1B is a table illustrating the differences between the Geiger-Mode lidar of the present disclosure and the legacy liner-mode lidar. As shown in FIG. 1A, each laser produces a map of laser spots having an area of 2 mrad by 2 mrad. As shown in FIG. 1A, this method results in many gaps in the scene. That is, the spares or distributed laser spots leave large non-illuminated and non-imaged gaps in the scene (i.e., the white areas surrounding the imaged regions in FIG. 1A). That is, the related art systems use linear or scatter mode lidar (transmitters) having an attenuated sensitivity to photons (e.g., 10s to 100s photons), and generating a single-shot image of a scene.

As shown in FIG. 1B, the linear-mode lidar has a sensitivity to 10s to 100s photons, produces a single-shot image of a scene, and includes discrete lasers and detectors creating gaps between imaged points and integrates commodity components. The liner-mode lidar also operates in the near infrared region of about 900 nm. On the contrary, as shown in FIG. 1B, the Geiger-mode lidar is sensitive to single photons (Geiger mode), includes a statistical sampling of the scene, operates in the shortwave infrared region (>1400 nm), includes an array of lasers and detectors and produces a gapless image of a scene. These features are described in more detail below.

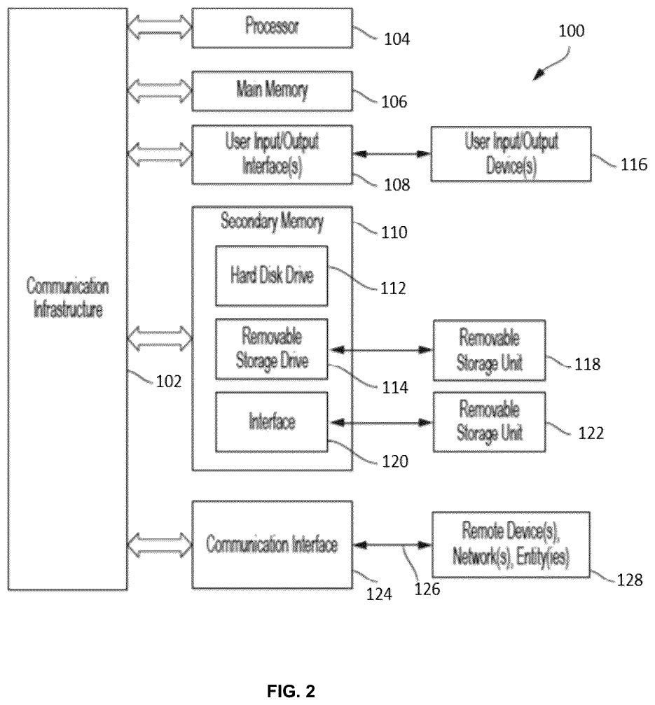

Next, FIG. 2 is a block diagram illustrating a computer system 100 for implementing embodiments of the invention. As shown, the computer system 100 includes one or more processors 104 (e.g., central processing units (CPUs)). The processors 104 can be connected to a communication infrastructure 102 such as a bus. Optionally, one or more of the processors can be a graphics processing unit (GPU). In some examples, a processor 104 (GPU) which is a specialized electronic circuit designed to process mathematically intensive applications can be used. The GPU includes a parallel structure that is efficient for parallel processing of large blocks of data, such as mathematically intensive data common to computer graphics applications, images, videos, etc.

As shown in FIG. 2, the computer system 100 also includes one or more user input/output devices or interfaces 108, such as monitors, keyboards, pointing devices, etc. The computer system 100 also includes a main or primary memory 106, such as random access memory (RAM). Further, the main memory may include one or more levels of cache and can further store control logic (i.e., computer software) and/or data for system operation. The computer system 100 can also include one or more secondary storage devices or memory 110. In some examples, the main memory can be considered as a “first” memory and a secondary memory can be considered as a “second” memory, or vice versa.

Alternatively, the secondary memory can include multiple subcomponents that together serve as the first and second memory. The secondary memory can further include, for example, a hard disk drive 112 and/or a removable storage device or drive 114. In particular, the removable storage drive 114 can be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

In addition, the removable storage drive 114 can also interact with a removable storage unit 118 and 122. Such a removable storage unit can include a computer usable or readable storage device having stored thereon computer software (control logic) and/or data. The removable storage unit can also be an external hard drive, a USB drive, a memory card such as a compact flash card or secure digital memory, a floppy disk, a magnetic tape, a compact disc, a DVD, an optical storage disk, and/any other computer data storage device. The removable storage drive can also read from and/or write to the removable storage unit.

Further, the secondary memory can include other mechanisms, instrumentalities or approaches for allowing computer programs and/or other instructions and/or data to be accessed by the computer system including, for example, a removable storage unit and an interface. Examples of the removable storage unit and the interface include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

As shown in FIG. 2, the computer system 100 may further include a communication or network interface 124 enabling the computer system to communicate and interact with any combination of remote devices, remote networks, remote entities 128. For example, the communication interface can allow the computer system to communicate with remote devices over a communications path, which may be wired and/or wireless, and which may include any combination of LANs, WANs, the Internet, etc. Control logic and/or data can also be transmitted to and from the computer system via the communication path.

In some embodiments, a tangible, non-transitory apparatus or a tangible, non-transitory computer useable or readable medium having control logic (software) stored thereon is also referred as a computer program product or program storage device. This includes, but is not limited to, the computer system, the main memory, the secondary memory, and the removable storage units, as well as tangible articles of manufacture embodying any combination of the foregoing. Such control logic, when executed by one or more data processing devices (such as the computer system), causes such data processing devices to operate as described in this document.

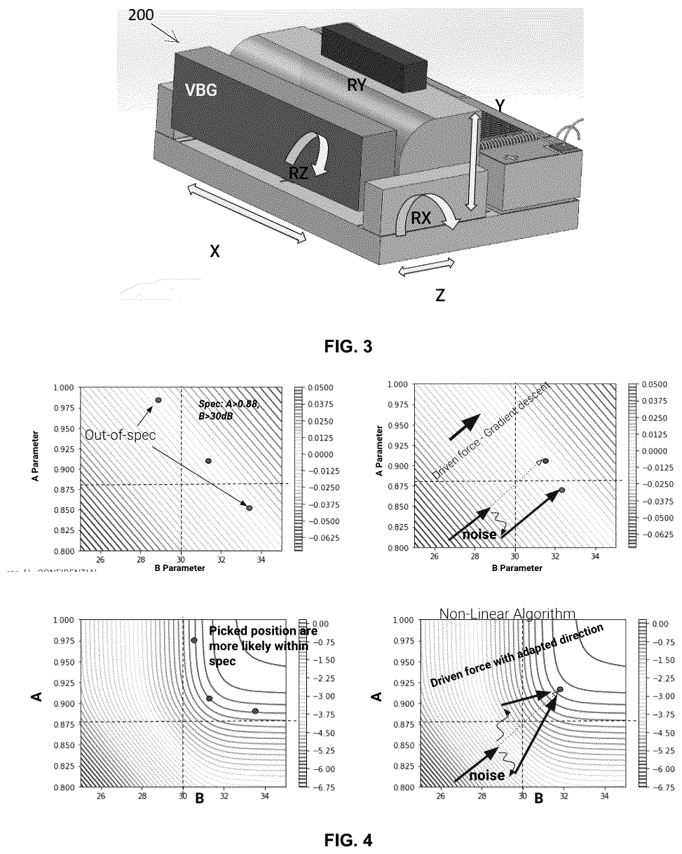

Next, FIG. 3 is an overview illustrating the multiple linear and rotational axes (x/y/z/Rx/Ry/Rz) of a laser diode 200. As shown in FIG. 3, for active alignments, the multiple linear and rotational axes (x/y/z/Rx/Ry/Rz) are preferably adjusted to find the optimal position. In real-time production conditions, it is common to have a strong axis coupling effect caused by alignment equipment limitations, process variations or internal physics of the optical system. Therefore, an axis is not scanned separately to find the best position for each axis. Instead, to find the optimal position, an area scan is used.

According to one embodiment of the present disclosure, the scan method finds the optimal alignment position of the laser diode 200 shown in FIG. 3 using a non-linear method. In more detail, FIG. 4 includes graphs illustrating the differences between a linear scan method and a non-linear scan method. That is, to address problems with the liner merit function, a non-linear merit function is used according to an embodiment of the present disclosure to achieve improved performance by avoiding the over-weighting of one parameter to ensure the chosen parameter will have a performance within specification. As shown in FIG. 4, the non-linear method also has a stronger resistance to external noise due to the adapted driven force direction. The non-linear method in the bottom of FIG. 4 also clearly illustrates the picked positions are more likely within the specification.

In addition, particularly for optical systems including VBG laser diodes, active alignment is necessary to find an optimal positions for the optical components. Related to this alignment, two challenges arise: 1) How to define the optimal position with non-independent parameters; and 2) How to effectively reach the optimal position for a coupled axis system. The present disclosure advantageously provides a method (algorithm) to identify optima position and an efficient scan method. Combining these methods achieves high yield and a faster process time.

In more detail, FIG. 5 is an image of a real scan profile, which illustrates a scan profile image captured by the laser module. To find an optimal position of the components in the laser module, the area scan can be utilized rather than scanning each axis separately to find the best position for each axis independently. Instead, to find the optimal position, the area scan is used. A fine line scan after the image scan can also be used to determine the final alignment.

In addition, an area scan method as shown in FIG. 5 includes a trade-off between time and accuracy. When the scan step is fine, which provides high accuracy, the scan process is time consuming. Also, reducing the scan time by increasing the scan steps reduces accuracy.

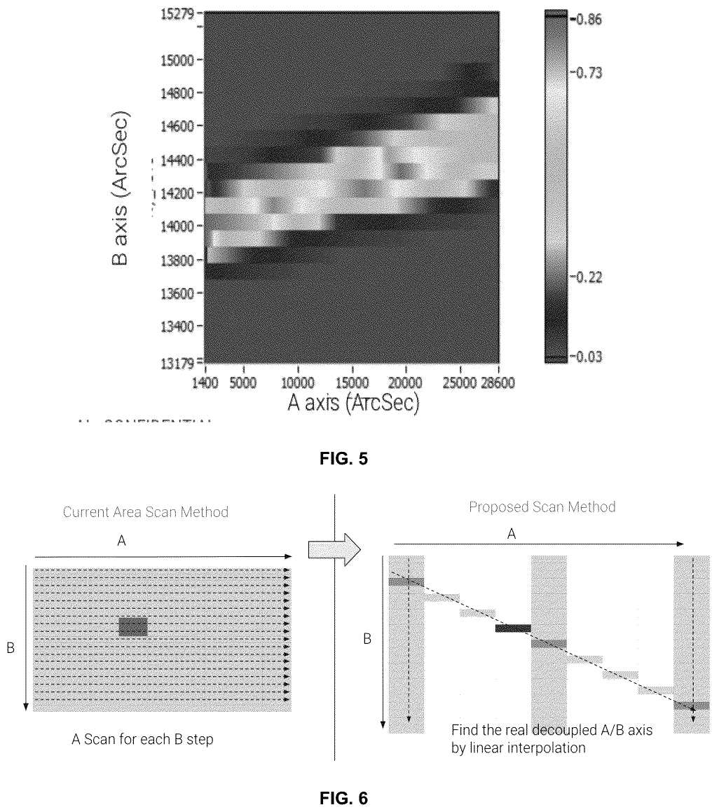

Accordingly, as shown in FIG. 6, an area scan can be used to accommodate the A/B coupling effect. In particular, it is preferable to find the “real” A axis and B axis which are decoupled with each other. A line scan approach can then be implemented to replace the area scan as shown in FIG. 6. In particular, FIG. 6 illustrates finding the real decoupled A/B axis using linear interpolation.

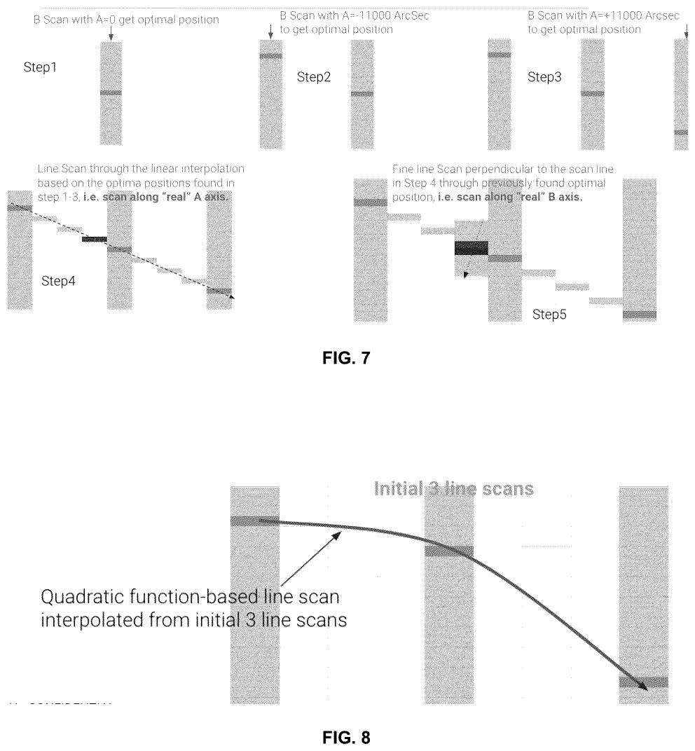

Further, FIG. 7 illustrates additional details of the scan with adjusted scan ranges. In particular, FIG. 7 illustrates five (5) scanning steps including a first step including a B scan with A=0. The second step includes a B scan with A=−11000 ArcSec, and the third step includes a B scan with A=+11000 ArcSec. Steps four and five include line scans through linear interpolation based on the previous steps to obtain scans along the real A and B axis.

According to one embodiment of the present disclosure, the system and method use function-based line scan operations to replace an area scan to perform active optical alignment. In one example, two initial scans may be sufficient for linear interpolation. However, as illustrated in FIG. 8, a third scan can be performed to improve accuracy. In particular, as shown in FIG. 8, if the peak position has quadratic behavior, three scans are preferably performed. That is, in FIG. 8, the quadratic function-based line scan is interpolated from three-line scans.

Thus, the above-described method can be advantageously applied to an alignment system where the axis are coupled. As an additional advantage, the above-described method lowers the requirement for axis alignment control (e.g., xyz, Rx/RyRz and pivot point) of the equipment allowing for a more efficient scan in a wider range of equipment. The active alignment methods described herein can be implemented as a non-linear algorithm for the optical active alignment that can globally optimize multiple non-independent parameters. This method is also resistant to environmental noise and can effectively reach an optimized position, thereby improving the yield of optical active alignment.

In addition, the function-based scan method can be generated based on the underlying physics and initial line scans. The number of line scans can also be determined by the fitting parameters needed to describe the peak positions. The non-linear algorithm to determine the optimal position for the laser module active alignment is also effective in improving production yield. Accordingly less manufacturing loss/waste is achieved. Further, this method is useful for cases with non-independent parameter merit function-based alignment. The non-linear scan method also significantly reduces the processing time and accuracy to find the real optimal position and is effective as a fast scan method for coupled axis systems.

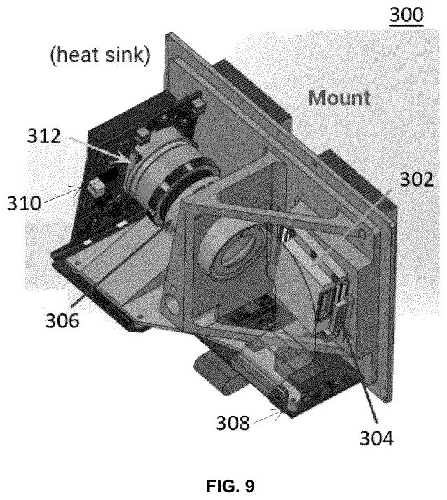

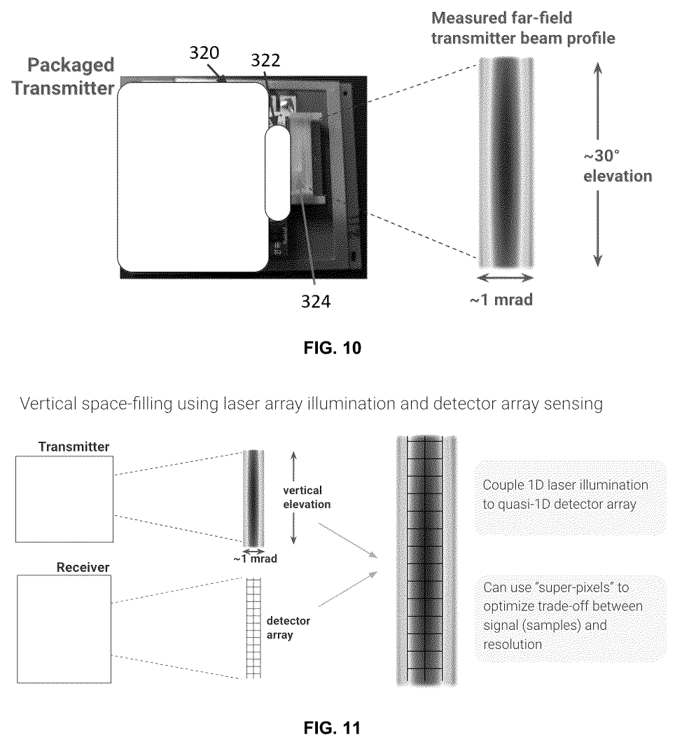

Next, FIG. 9 is an overview of a lidar 300 transceiver which includes a laser module 302, transmission optics 304, receiver optics 306, a transceiver interface board 308, an FPA Board 310 and a FPA module 312. As shown in FIG. 10 in more detail, the transmitter module includes a driver circuit 320, a laser diode array 322 and micro lens optics 324. The laser diode array 322 can be a one-dimensional high-power array with a predetermined number of emitters (e.g., 48). Further, the emitted light passes through micro-optics that focus the beam and lock the desired wavelength. The driver circuit can also be designed for high-current/short laser pulses (e.g., 3-6 ns). In particular, the transmitted pulse energy can be ˜2 uJ in ˜5 ns pulses.

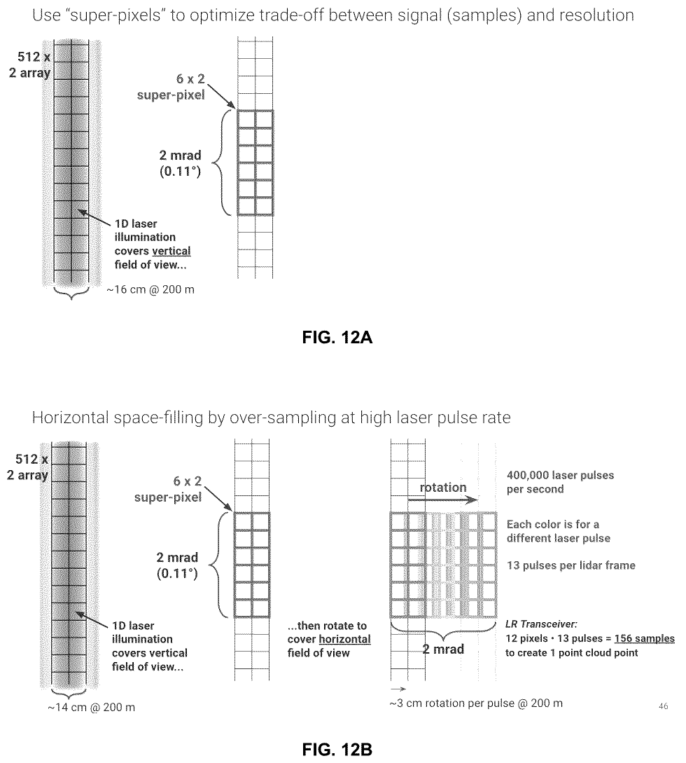

In addition, the gapless imaging described above can further be achieved with over-sampling techniques as depicted in FIGS. 10-12, for example. In more detail, as shown in FIG. 10, the 1D laser illumination covers a field of view of ˜30 degrees, which when rotated can cover an entire scene. That is, FIG. 10 illustrates the measured far-field transmitter beam profile having a ˜30-degree elevation and a ˜1 mrad width. FIG. 11 illustrates a vertical space-filling method using a vertically stacked laser array. That is, in FIG. 11, the method includes coupling the 1D laser illumination to a qausi-1D detector array and using super-pixels to optimize the trade-ff between the signal (samples) and the resolution. The configured resolution is illustrated in more detail in FIGS. 12A and 12B.

That is, as shown in FIGS. 12A and 12B, over-sampling techniques are applied to capture a more robust 3D point cloud of the surrounding environment. This is especially advantageous for autonomous mobility in which detection of objects surrounding an AV at short and long distances is used for safe navigation.

In addition, the malfunction or inoperation of individual emitters causes gaps or other nonuniformities in the output of the laser diode array. Therefore, according to one embodiment, the output of the individual laser emitters is distributed such that an aggregate sum of all output from the plurality of emitters is homogeneous as received at a target object. That is, the embodiment provides for uniform illumination from an array of a plurality of laser emitters.

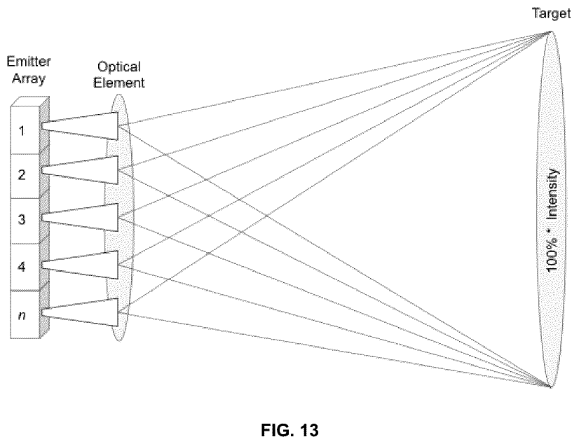

In more detail, as shown in FIG. 13, a monolithic optical element is separated from the laser diode array and within the field of light emission to influence the shape of the light output from the emitters. The optical element is also aligned to project the output of the individual emitters onto an entire field, as shown in FIG. 13. Therefore, the aggregate intensity can remain substantially uniform across the field, even when one or more laser emitters malfunction or become inoperable. In addition, the optical element can be a standalone optical element or be part of a micro-optics array configured to focus the laser pulses into a desired scanning beam.

As shown in FIG. 13, the emitter array can include any number of individual emitters 1 to n. More specifically, the emitters can be arranged in a vertical 1D array and emit light in a lateral direction to scan and detect objects external to an autonomous vehicle. According to a specific example above, a laser diode array can include 48 emitters in a vertically stacked array. Because the monolithic optical element is introduced into the field of light emission, a substantially monolithic light intensity can be achieved across the entire field of light emission. Therefore, the total light intensity would equal the cumulative light emitted from the sum of the emitters in the laser array as shown in FIG. 13.

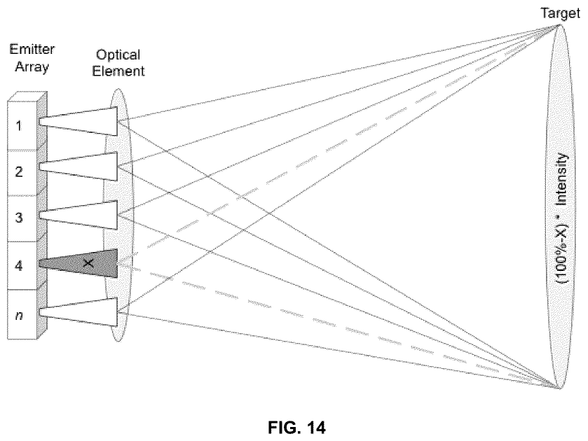

However, individual emitters may malfunction or otherwise become inoperable, diminishing the light field emitted from the laser array. For example, FIG. 14 illustrates an emitter #4 in the array as having become inoperable. Thus the field of light associated with the inoperable emitter is inactive. As illustrated on the right side of FIG. 14, the intensity of the cumulative light received at the target is reduced by a magnitude equal to the absent light formerly output from laser emitter #4 (i.e., X). However, since the light output from each of the individual emitters is distributed across the broad field of light emission, the intensity of the light received across the target remains substantially uniform.

In addition, the reduction in intensity due to the absence of one emitter is an insignificant overall power reduction. Therefore, the light returned from the object is more reliable due the lack of any gaps in the light field, coupled with the insignificant overall loss in intensity of light returned from the object. Accordingly, the lidar system according to an embodiment of the present disclosure is less sensitive to failures or malfunctions of individual laser emitters and the durability of the lidar assembly is improved. That is, if a single emitter comes inoperable, the array or the lidar assembly may have to be serviced. However, in the present disclosure, the emitter parts are not replaced thereby avoid time consuming service downtime. Further, the digital signal processing (DSP) burden is relatively unaffected by the failure of single emitters. That is, the homogenous character of the field of emitted light improves the consistency of the data output from the lidar device that is fed to DSP components for processing.

In addition, a lidar sensor operating on an AV can include a combination of hardware components (e.g., transceiver apparatus including a transmitter assembly and a receiver assembly, processing circuitry, cooling systems, etc.), as well as software components (e.g. software code and algorithms that generate 3D point clouds and signal processing operations that enhance object detection, tracking, and projection).

Various embodiments described herein may be implemented in a computer-readable medium using, for example, software, hardware, or some combination thereof. For a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. For a software implementation, the embodiments such as procedures and functions may be implemented together with separate software modules each of which performs at least one of functions and operations. The software code can be implemented with a software application written in any suitable programming language. Also, the software codes may be stored in the memory and executed by the controller.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An optical transmitter, comprising:
a laser diode array configured to emit corresponding laser pulses;
a micro-optics module configured to focus the laser pulses into a scanning beam; and
a drive motor configured to rotate the optical transmitter so the scanning beam covers a horizontal field of view.

2. The optical transmitter of claim 1, wherein the micro-optics is disposed a predetermined distance in front of the laser diode array.

3. The optical transmitter of claim 1, wherein the laser diode array include n number of laser emitters configured to emit n number of laser pulses.

4. The optical transmitter of claim 3, wherein n=48.

5. The optical transmitter of claim 3, wherein the micro-optics module focuses the laser pulses into the scanning beam to have a specific intensity of cumulative light at a target.

6. The optical transmitter of claim 5, wherein when a corresponding laser emitter “x” is inoperable, the micro-optics module focuses the laser pulses into the scanning beam to have the specific intensity of the cumulative light at the target that is equal to (110%-x)*Intensity.

7. The optical transmitter of claim 1, wherein the laser diode array comprise a vertically stacked array of light emitters.

8. The optical transmitter of claim 1, wherein the optical transmitter is an autonomous vehicle optical transmitter.

9. The optical transmitter of claim 1, further comprising:
a controller configured to perform an initial number of line scans and determine a scan path to reach a predetermined optimal position.

10. The optical transmitter of claim 9, wherein the controller is further configured to determine the scan path based on a predetermined function.

11. The optical transmitter of claim 10, wherein the controller is further configured to determine an alignment of the optical transmitter based on the determined scan path.
